(19) United States
(12) Patent Application Publication
(10) Pub. No.: US 2025/0151652 A1
(43) Pub. Date: May 15, 2025

(54) CONVEYING SYSTEM WITH DEBRIS CLEARING DEVICE FOR HARVESTING MACHINE

(71) Applicant: ContiTech Antriebssysteme GmbH, Hannover (DE)

(72) Inventor: Ben Roberts, Lincoln, NE (US)

(73) Assignee: ContiTech Antriebssysteme GmbH, Hannover (DE)

(21) Appl. No.: 18/510,062

(22) Filed: Nov. 15, 2023

(51) Int. Cl. A01D 75/18; A01F 12/16

(52) U.S. Cl. CPC A01D 75/187; A01F 12/16

(57) ABSTRACT

A conveying system for a harvesting machine includes a sprocket with multiple sprocket teeth and a pair of adjacent belts that engage the sprocket teeth and rotate around the sprocket to transport crop material. Positioned between the adjacent belts is a debris clearing device that effectively prevents crop material from entering between the belts and the sprocket teeth. This mitigates the risk of blockages and damage to the system, ensuring smooth and efficient operation of the conveying system in the harvesting machine.

### FIELD

The field to which the disclosure generally relates is harvesting machines, and more particularly to feeder house belt and/or chain operation.

### BACKGROUND

This section provides background information to facilitate a better understanding of the various aspects of the disclosure. It should be understood that the statements in this section of this document are to be read in this light, and not as admissions of prior art.

Agricultural harvesting machines such as combine harvesters are used to reap, thresh, and winnow grain crops such as wheat, rye, barley, corn, soybeans, oats, flax, sunflower, and canola. More specifically, combine harvesters are used to cut grain crops at the base, separate the grains from the remainder of the plant (the chaff), and sort the grain from the chaff. These machines require special adaptations to accommodate specific crops, navigate through field landscapes, and resist damage from the crops, stone, and the elements; especially moisture and high temperature which can lead to the degradation of the machine's rubber components.

Generally harvesting machines gather crops using a header having crop dividers which define crop gathering gaps as the machine moves through a field. The gathered crops are pushed by a reel into a cutter bar, which runs the length of the header and is equipped with teeth made of metal or plastic to cut crops at their base. Headers may have a rigid or flexible header platform depending upon the operational needs and the crop being harvested. Flexible header platforms or “flex headers” have a cutter bar which is capable of flexing over uneven terrain. Machines using flex headers are most often used to cut soybeans, whereas conventional header platforms have a rigid cutter bar and are most often used to cut cereal crops. Freshly cut crops fall behind the cutter bar and onto a plurality of side by side draper belts which are wrapped around parallel spaced rollers. Draper belts function primarily to consolidate crops and move the crops from the header towards the threshing drum. Crops are fed into the threshing drum by spinning augurs. Inside the threshing drum, the grains are shaken from the plant. Grains fall through sieves into a grain collecting tank, and the plant waste, or chaff, is moved to the back of the machine for disposal.

A feeder house inputs the crop material using multiple belts and/or chains to help convey the material using guide bars into the harvesting machine. The belts and/or chains run on sprockets having teeth that engage the belts and/or chains. However, it is appreciated that the harvesting machines encounter various conditions that can cause the belts and/or chains to skip and the like. This can result in a variety of problems including damage to the machine, loss of material and the like.

Accordingly, there is a need to facilitate feeder chain and/or belt operation.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein.

FIG. 1 shows a general cross-sectional view of an agricultural harvesting machine.

FIG. 2 is a diagram illustrating another view of the harvesting machine 19.

FIG. 3 is a diagram illustrating synchronization sprockets in a feeder housing 300 in accordance with one or more embodiments.

FIG. 4 is a front view of the housing 400 in accordance with one or more embodiments.

FIG. 5 is a close up view of the feeder housing 500 in accordance with one or more embodiments.

FIG. 6 is another view 600 of the feeder housing showing conveying devices 502.

FIG. 7 is another view 700 of the feeder housing.

FIG. 8 is a diagram illustrating a debris clearing device 804 in accordance with one or more embodiments.

FIG. 9 is a diagram illustrating a debris clearing device 904 in accordance with one or more embodiments.

### DETAILED DESCRIPTION

The following description of the variations is merely illustrative in nature and is in no way intended to limit the scope of the disclosure, its application, or uses. The description and examples are presented herein solely for the purpose of illustrating the various embodiments of the disclosure and should not be construed as a limitation to the scope and applicability of the disclosure. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a value range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

Feeder housings for harvesting machines are commonly used in agricultural operations to efficiently and effectively transport harvested crops from the field into the machine for further processing. These feeder housings typically include a drive shaft positioned at the entrance of the housing, which is responsible for driving the conveyance devices that move the crops along the housing. The conveyance devices are usually in the form of belts or chains that are wrapped around the drive shaft and are equipped with cross bars to facilitate the movement of the crops.

One or more embodiments are disclosed that facilitate feeder housing chain and/or belt operation.

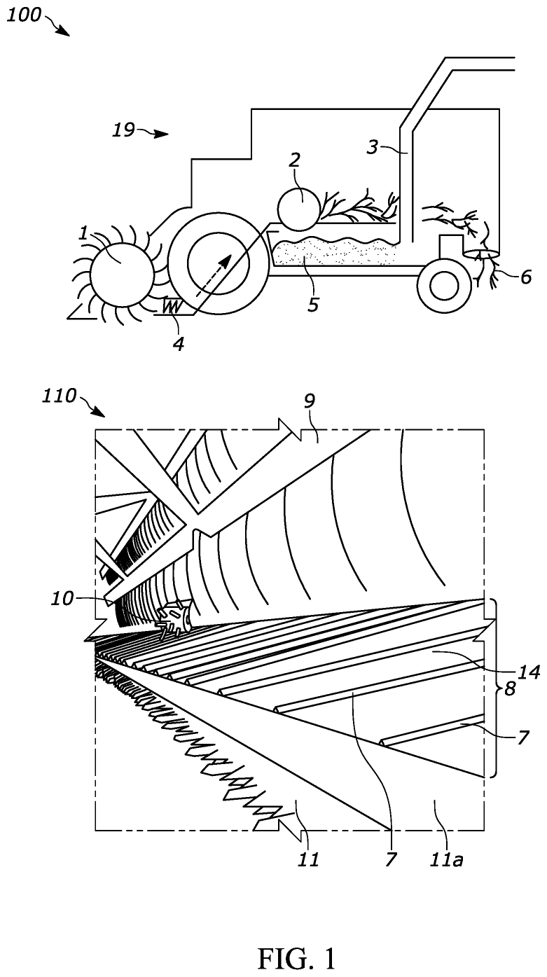

FIG. 1 describes a harvesting machine 19 in accordance with one or more embodiments.

Harvesting machines typically includes a cutter bar, conveying system, a reel, and the like.

Cutter Bar: The front part of the feeder housing houses the cutter bar, which is equipped with a series of cutting blades or cutting discs. These blades cut through standing crops, such as grains like wheat or corn, or other plants like soybeans, as the harvester moves through the field.

Auger or Conveying System: Once the crops are cut, they need to be transported from the cutter bar to the internal mechanisms of the harvester. This is usually accomplished through an auger or a conveying system. An auger is a spiral-shaped device that uses rotating helical blades to move the harvested material. A conveying system involves a series of belts, chains, or rollers that move the cut crops towards the center of the machine.

Reel: Some feeder housings feature a reel, also known as a pickup reel or crop lifter, located above the cutter bar. The reel helps lift lodged or tangled crops to ensure a clean and consistent cutting height. It also assists in guiding the cut crops towards the auger or conveying system.

Height Control: Feeder housings often have height control mechanisms that allow operators to adjust the height at which the cutter bar operates above the ground. This is crucial for adapting to varying crop conditions and field terrains.

Flexibility and Contouring: In modern harvesting machines, feeder housings can be equipped with features that enable contouring to match the ground's surface. This ensures that the cutter bar maintains consistent contact with the ground, improving the efficiency of crop intake and minimizing losses.

Safety Features: Feeder housings are designed with safety features to prevent debris or foreign objects from entering the internal machinery and causing damage. This may include protective screens, guards, and sensors that detect potential blockages.

Header Width: Feeder housings come in various widths to accommodate different field sizes and crop types. Wide headers are suitable for large, open fields, while narrower headers are used in more constrained environments.

Integration: The feeder housing is seamlessly integrated with the overall harvesting machine's control and automation systems. It is often adjustable and can be easily connected or detached to adapt to various harvesting needs.

Durability: Feeder housings are built to withstand the demanding conditions of agricultural operations. They are made from sturdy materials to handle the stresses of cutting and gathering crops.

A feeder housing is an important component of a harvesting machine that performs the critical task of cutting, gathering, and transporting crops into the internal processing mechanisms. It's designed for efficiency, adaptability, safety, and durability to optimize the harvesting process in various agricultural settings.

The feeder housing has a conveying system that typically includes cross members between a plurality of chains and/or belts, which rotate about a drive shaft with toothed sprockets to positively engage the belts and/or chains and cause rotation of the system. The cross members help convey material about the conveyor system. A non driving shaft can be present and also include tooths to also positively engage the belts and/or chains to transfer power and the like.

An example of a harvesting machine 19 is shown in FIG. 1. The machine 19 includes a reel 1, a cutter bar 4, a threshing drum 2, and a grain elevator 3. The reel 1 functions to move crops into the cutter bar 4 which cuts the crops at their base using metal or plastic teeth. Cut crops fall upon a plurality of side by side draper belts which consolidate the crops and move them towards the threshing drum 2. The threshing drum 2 beats and breaks the crops to shake the grains 5 from the remainder of the plant, also known as the chaff 6. The grains 5 are collected inside a grain collecting tank and the machine disposes of the chaff 6 through the back of the machine 19, and grains 5 are moved from the grain tank at a grain elevator 3.

An exploded portion 110 of FIG. 1 shows a section of a harvesting machine having a reel 9, a feeding drum 10, a cutter bar 11, a crop ramp 11a, and a draper belt 8 having cleats 7 located on carry layer 14. The carry 14 layer can be chosen from a wide variety of rubbery polymers having a desired combination of physical properties and chemical resistance.

The use of sprockets at each belt location on the front drum 10 facilitates to keep belts or chains synchronized.

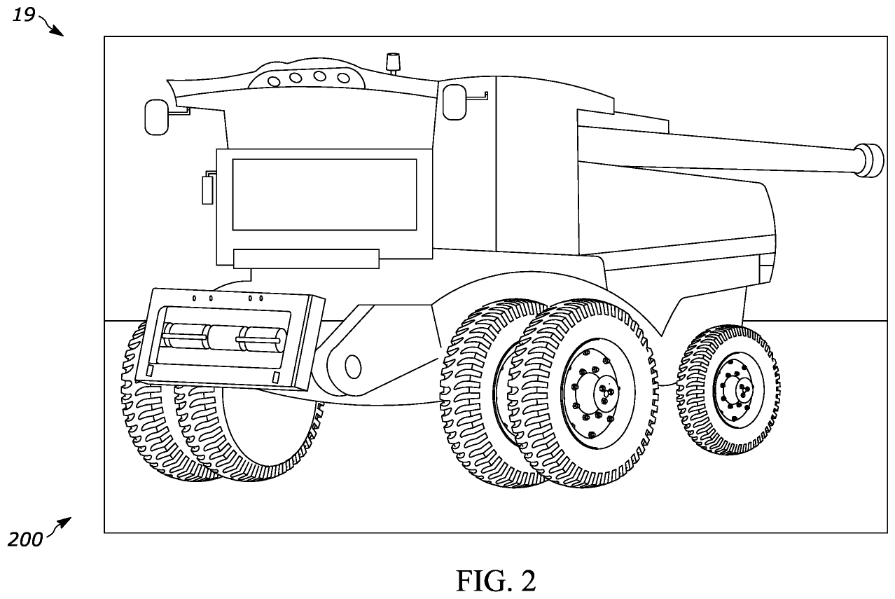

FIG. 2 is a diagram illustrating another view of the harvesting machine 19.

The view further illustrates a feeder house/housing 200 at a front of the machine.

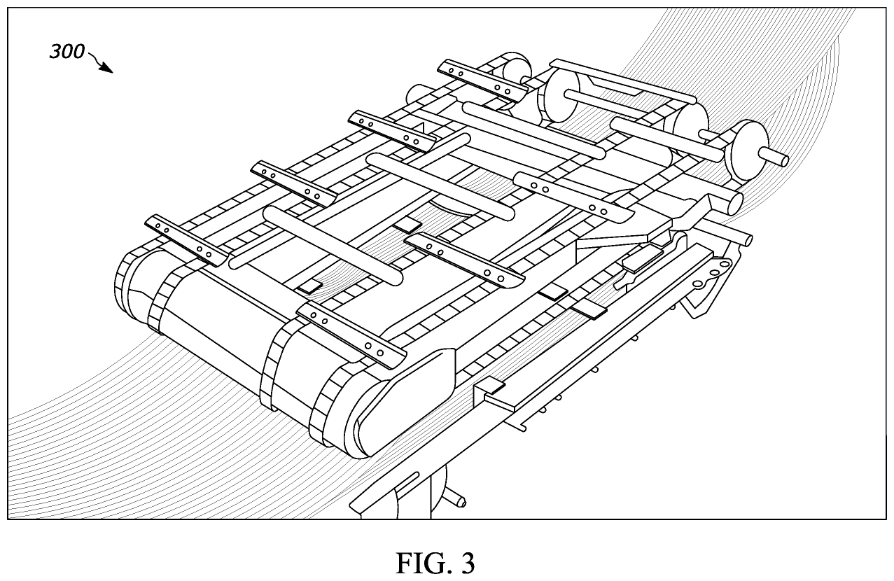

FIG. 3 is a diagram illustrating synchronization sprockets in a feeder housing 300 in accordance with one or more embodiments. It is appreciated that the housing 300 is provided for illustrative purposes and that suitable variations are contemplated.

The housing 300, in this example, is shown with two pairs of belts wrapped around sprockets on each side of the feeder housing 300.

A front of the housing 300 on the left of the diagram receives material and an exit of the housing providing the receive material to another component, such as a draper belt.

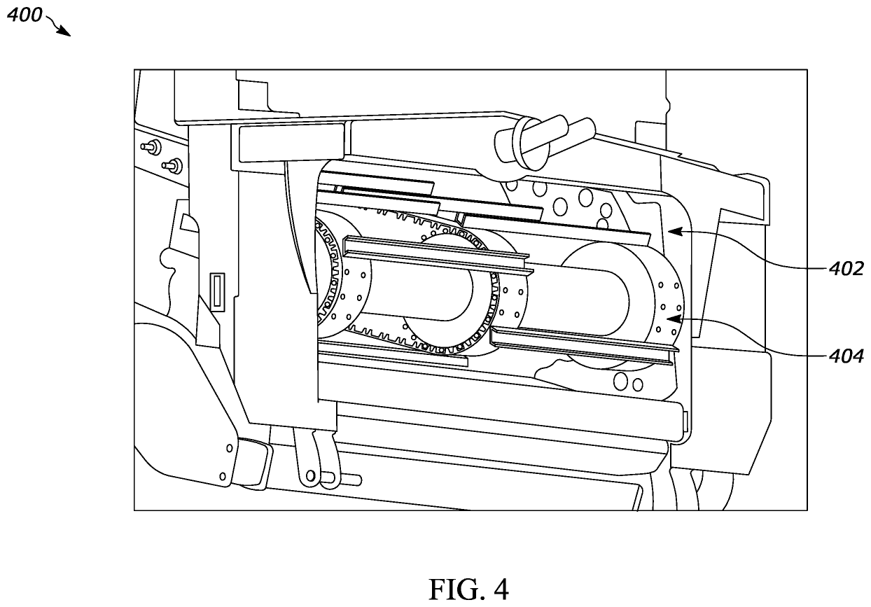

FIG. 4 is a front view of the housing 400 in accordance with one or more embodiments.

Sprockets 404 are shown with bars 402 attached between belts. There are 3 belts seen in this example.

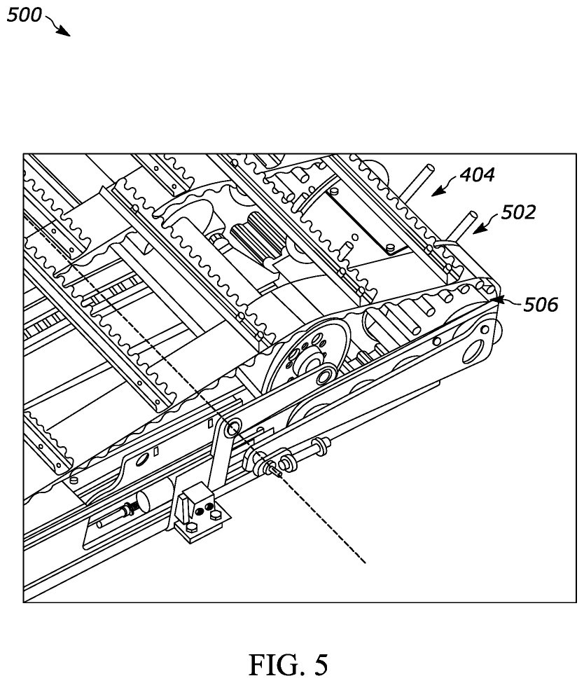

FIG. 5 is a close up view of the feeder housing 500 in accordance with one or more embodiments. It is appreciated suitable variations are contemplated.

Here, a sprocket 506 is shown that engages with feeder conveying devices 502. The conveying devices can include belts, chains, elastomeric belts and the like.

Cross bars or cutter bars 404 are also shown.

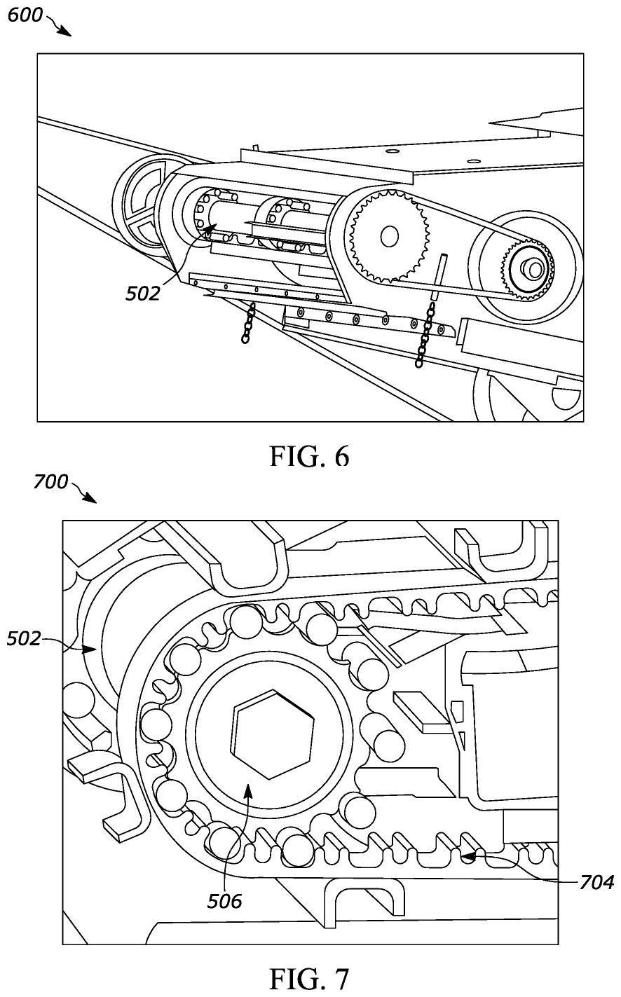

FIG. 6 is another view 600 of the feeder housing showing conveying devices 502.

FIG. 7 is another view 700 of the feeder housing.

An outer side of the sprocket 506 is showing having a cap to protect the shaft.

The conveyance device 502 in this example is a belt having interior teeth 704 that engage teeth of the sprocket 506.

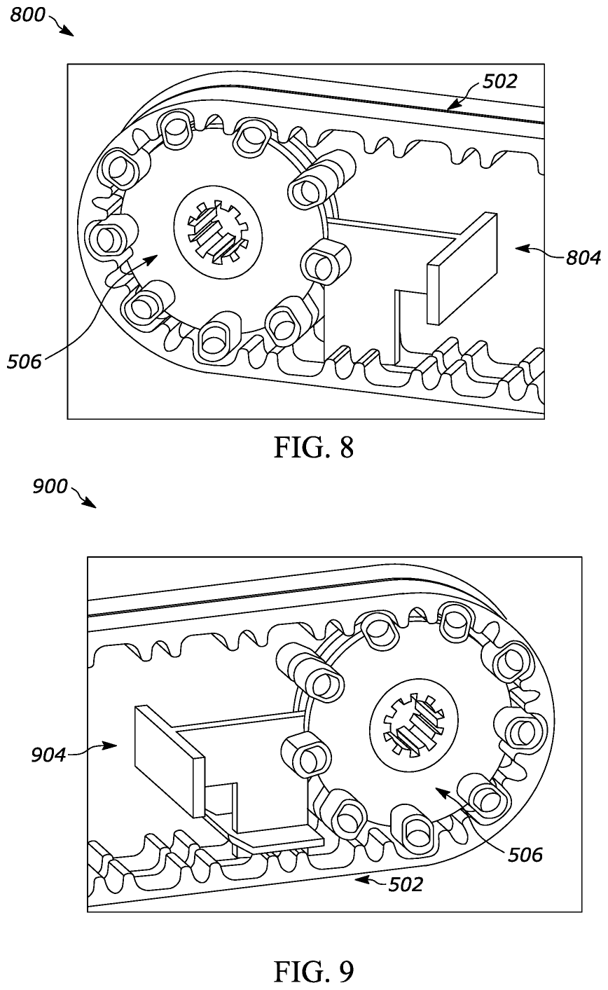

FIG. 8 is a diagram illustrating a debris clearing device 804 in accordance with one or more embodiments.

The debris clearing device 802 is shown having a plow shape, however it is appreciated that other suitable shapes are contemplated.

The clearing device 804 is configured to remove material from an interior surface or teeth of the conveying device 502 so that the material does not clog or encounter the sprocket 506.

The clearing device 804 can be attached to other components of the harvesting machine 19. In one example the device 804 is attached to structure of the feeder housing 200.

The clearing device 804 is positioned between two adjacent belts of 502 and running on a common sprocket 506.

FIG. 9 is a diagram illustrating a debris clearing device 904 in accordance with one or more embodiments.

The device 904 is similar to the device 804. However, the device 904 includes an additional clearing surface proximate the conveying device 502.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

In some aspects, the techniques described herein relate to a conveying system for a harvesting machine, the system including: a sprocket having a plurality of sprocket teeth; a pair of adjacent belts that engage the sprocket teeth and rotate about the sprocket to convey crop material; a debris clearing device positioned between the adjacent belts to mitigate crop material entering between the belts and the sprocket teeth.

In some aspects, the techniques described herein relate to a system, the debris clearing device is stationary.

In some aspects, the techniques described herein relate to a system, the debris clearing device adjustable about a feeder housing.

In some aspects, the techniques described herein relate to a system, the debris clearing device including metal.

In some aspects, the techniques described herein relate to a system, the debris clearing device having a plow portion.

In some aspects, the techniques described herein relate to a system, the debris clearing device further including a clearing device.

In some aspects, the techniques described herein relate to a system, the clearing device configured to dislodge debris from an interior surface of the adjacent belts and the plow portion configured to convey dislodged debris away from the harvesting machine.

In some aspects, the techniques described herein relate to a system, the sprocket and clearing device included within a feeder housing.

In some aspects, the techniques described herein relate to a system, further including a second sprocket, second adjacent belts and a second debris clearing device.

In some aspects, the techniques described herein relate to a system, the sprocket included within a draper belt system.

In some aspects, the techniques described herein relate to a harvesting machine including: a feeder housing having a plurality of feeder conveyance devices at a first end to feed crop material into the harvesting machine and convey the crop material; a collecting tank; a draper belt to convey the crop material from the feeder to the collecting tank; and a debris clearing device to remove debris from an interior surface of the feeder conveyance devices.

In some aspects, the techniques described herein relate to a harvesting machine, further including a sprocket proximate the debris clearing device.

In some aspects, the techniques described herein relate to a harvesting machine, the conveyance devices including adjacent belts.

In some aspects, the techniques described herein relate to a harvesting machine, the conveyance devices including adjacent chains.

In some aspects, the techniques described herein relate to a harvesting machine, further including one or more additional debris clearing devices.

In some aspects, the techniques described herein relate to a feeder housing for a harvesting machine, the housing including: a drive shaft positioned at an entrance of the housing and having a plurality of drive sprockets; a plurality of conveyance devices wrapped around the drive shaft; a plurality of cross bars attached between the plurality of belts; and the plurality of drive sprockets have a plurality of teeth to engage and synchronize the plurality of conveyance devices.

In some aspects, the techniques described herein relate to a housing, the drive shaft transfers power to the plurality of conveyance devices by the drive sprockets.

In some aspects, the techniques described herein relate to a housing, the plurality of conveyance devices including elastomeric belts.

In some aspects, the techniques described herein relate to a housing, the plurality of conveyance devices including chains.

In some aspects, the techniques described herein relate to a housing, further including a second shaft positioned at an exit of the housing.

In some aspects, the techniques described herein relate to a housing, the second shaft having a plurality of second sprockets to engage the plurality of conveyance devices.

In some aspects, the techniques described herein relate to a housing, the drive shaft having a hexagonal cross section.

In some aspects, the techniques described herein relate to a housing, the drive shaft having a circular cross section.

In some aspects, the techniques described herein relate to a housing, the crossbars each attach to at least two of the conveyance devices.

In some aspects, the techniques described herein relate to a housing, the shaft further including shielding to mitigate material wrapping around the shaft.

In some aspects, the techniques described herein relate to a housing, the crossbars having teeth to facilitate conveying material.

In some aspects, the techniques described herein relate to a housing, the teeth including cylinders to engage the conveyance devices.

In some aspects, the techniques described herein relate to a harvesting machine including: a feeder housing having a plurality of feeder conveyance devices at a first end to feed crop material into the harvesting machine and convey the crop material; a collecting tank; a draper belt to convey the crop material from the feeder to the collecting tank; and a plurality of sprockets to engage and synchronize the feeder conveyance devices.

In some aspects, the techniques described herein relate to a harvesting machine, further including a second plurality of sprockets to engage and synchronize the draper belt.

In some aspects, the techniques described herein relate to a harvesting machine, the feeder conveyance devices including a plurality of belts.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A conveying system for a harvesting machine, the system comprising:
a sprocket having a plurality of sprocket teeth;
a pair of adjacent belts that engage the sprocket teeth and rotate about the sprocket to convey crop material; and
a debris clearing device positioned between the adjacent belts to mitigate crop material entering between the belts and the sprocket teeth.

2. The system of claim 1, the debris clearing device is stationary.

3. The system of claim 1, the debris clearing device adjustable about a feeder housing.

4. The system of claim 1, the debris clearing device comprising metal.

5. The system of claim 1, the debris clearing device having a plow portion.

6. The system of claim 5, the debris clearing device further comprising a clearing device.

7. The system of claim 6, the clearing device configured to dislodge debris from an interior surface of the adjacent belts and the plow portion configured to convey dislodged debris away from the harvesting machine.

8. The system of claim 1, the sprocket and clearing device comprised within a feeder housing.

9. The system of claim 1, further comprising a second sprocket, second adjacent belts and a second debris clearing device.

10. The system of claim 1, the sprocket comprised within a draper belt system.

11. A harvesting machine comprising:
a feeder housing having a plurality of feeder conveyance devices at a first end to feed crop material into the harvesting machine and convey the crop material;
a collecting tank;
a draper belt to convey the crop material from the feeder to the collecting tank; and
a debris clearing device to remove debris from an interior surface of the feeder conveyance devices.

12. The harvesting machine of claim 11, further comprising a sprocket proximate the debris clearing device.

13. The harvesting machine of claim 11, the conveyance devices comprising adjacent belts.

14. The harvesting machine of claim 11, the conveyance devices comprising adjacent chains.

15. The harvesting machine of claim 11, further comprising one or more additional debris clearing devices.
